(19) United States
(12) Patent Application Publication
(10) Pub. No.: US 2006/0015483 A1
(43) Pub. Date: Jan. 19, 2006

(54) SQL query enhancement technique

(75) Inventor: Srilekha Krishnan Gownder, Austin, TX (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/892,436

(22) Filed: Jul. 15, 2004

(51) Int. Cl. G06F 7/00

(52) U.S. Cl. 707/3

(57) ABSTRACT

The invention comprises a query generator program and an improved client program adapted to use the query generator program. The improved client program comprises a query template that includes one or more query clauses and parameter data. Query clauses include parameter markers that operate as placeholders for dynamic parameters. Parameter data comprises a data type character and a program variable. The improved client program accepts a dynamic parameter from a user, or calculates it at run-time, and then replaces the program variable in the query template with the dynamic parameter. The query generator program then processes the modified query template to generate a query string. The client program then can process the query string further, or pass the string on to a DBMS as a query statement.

### FIELD OF THE INVENTION

The invention described below generally relates to data processing apparatus and the corresponding methods for the retrieval of data stored in a database or as computer files. In particular, the invention described below comprises subject matter directed to methods for translating an external access to a database or files into internal access to the database or files, and translation of an external query format into an intermediate or internal query format.

### BACKGROUND OF THE INVENTION

In general, a database is any collection of information organized for rapid search and retrieval. Generally, a user interacts with a database through a database management system (DBMS). Most modern DBMSs support a standard structured query language (SQL), through which a user can specify exactly what information a database should store or retrieve for the user.

Computer programmers also commonly develop programs that that interact with a DBMS, often using SQL or some minor variation adapted for use in such programs. A program that interacts with a DBMS is referred to generically as a “client” program. Many client programs also provide a user interface that allows a user to enter specific types of data, referred to herein as “parameters,” that control the operation of the program.

Computer programmers frequently implement helpdesk applications as a client program that interacts with a DBMS. A helpdesk application generally helps analysts manage problems, but more particularly, a helpdesk application registers and tracks calls from customers, and tracks the resolution of problems that customers identify. International Business Machines, Inc. (IBM) has developed such a helpdesk application, which IBM markets as Tivoli Service Desk (TSD). TSD provides a graphical user interface (GUI) through which users interact with the DBMS. TSD, like most helpdesk applications, needs to be flexible and responsive to a variety of complex scenarios. Consequently, TSD must be able to generate database queries based on parameters supplied by a user at run-time. IBM originally incorporated a proprietary language, commonly referred to as Knowledge Markup Language (KML), into TSD, which allowed TSD to accept user input and generate dynamic queries for the underlying DBMS. TSD comprises three components: (1) Tivoli Problem Management (TPM); (2) Tivoli Change Management (TCM); and (3) Tivoli Asset Management (TAM). TPM enables a helpdesk analyst to store data about customer-identified problems in a database, and update that data as the analyst works to resolve the problem. TCM enables an enterprise to store data about process changes in a database, and update that data as the enterprise implements the process changes. TAM enables an enterprise to store information about its assets in a database, and update that information as the asset ages.

TSD and the underlying DBMSs have continued to evolve, though, and some of the original methods for generating dynamic queries, implemented in the original proprietary language, do not function properly with some DBMSs. In particular, some of these methods do not operate with new DBMSs that support the Unicode standard.

TSD, though, is just one example that highlights a general need in the art for an improved means of using user-supplied parameters to generate a query that any DBMS can process. The invention described below provides a means that addresses this need. This and other objects of the invention will be apparent to those skilled in the art from the following detailed description of a preferred embodiment of the invention.

### SUMMARY OF THE INVENTION

The invention described below is a process for using dynamic parameters supplied by a user, or otherwise determined at run-time, to generate a database query string suitable for further processing in any database management system that supports a structured query language.

The invention comprises a query generator program and an improved client program adapted to use the query generator program. The improved client program comprises a query template that includes one or more query clauses and parameter data. Query clauses include parameter markers that operate as placeholders for dynamic parameters. Parameter data comprises a data type character and a program variable. The improved client program accepts a dynamic parameter from a user, or calculates it at run-time, and then replaces the program variable in the query template with the dynamic parameter. The query generator program then processes the modified query template to generate a query string. The client program then can process the query string further, or pass the string on to a DBMS as a query statement.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates the internal configuration of a computer having the computer program of the present invention loaded into memory;

FIG. 2 illustrates a prior art architecture for connecting various hardware devices to create a network for transferring data from one computer to another;

FIG. 3 illustrates an embodiment of the improved client program adapted to use the query generator program;

FIG. 4 is an exemplary query template;

FIG. 5 illustrates a preferred embodiment of query generator program;

FIG. 6 is a KML source code listing of the query generator program; and

FIG. 7 traces the variables used in FIG. 6 using the exemplary query template of FIG. 4.

### DETAILED DESCRIPTION OF THE PREFERRED EMBODIMENT

A person of ordinary skill in the art will appreciate that the present invention may be implemented in a variety of software and hardware configurations. It is believed, however, that the invention is described best as a computer program that configures and enables one or more general-purpose computers to implement the novel aspects of the invention.

The internal configuration of a computer, including connection and orientation of the processor, memory, and input/output devices, is well known in the art. FIG. 1 represents the internal configuration of a computer having the computer program of the present invention loaded into memory 100. The computer program of the present invention is depicted as client program 120, which comprises GUI 130, database interface (DBI) 140, and query generator 150. Client program 120 interacts with database 160 (not pictured), which may reside in memory 100. Memory 100 is only illustrative of memory within a computer and is not meant as a limitation. Memory 100 also contains resource data 110. The present invention may interface with resource data 110 through memory 100.

In alternative embodiments, client program 120 and its components, as well as database 160 can be stored in the memory of other computers. Storing client program 120 and database 160 in the memory of other computers allows the processor workload to be distributed across a plurality of processors instead of a single processor. Further configurations of client program 120 and database 160 across various multiple memories and processors are known by persons skilled in the art.

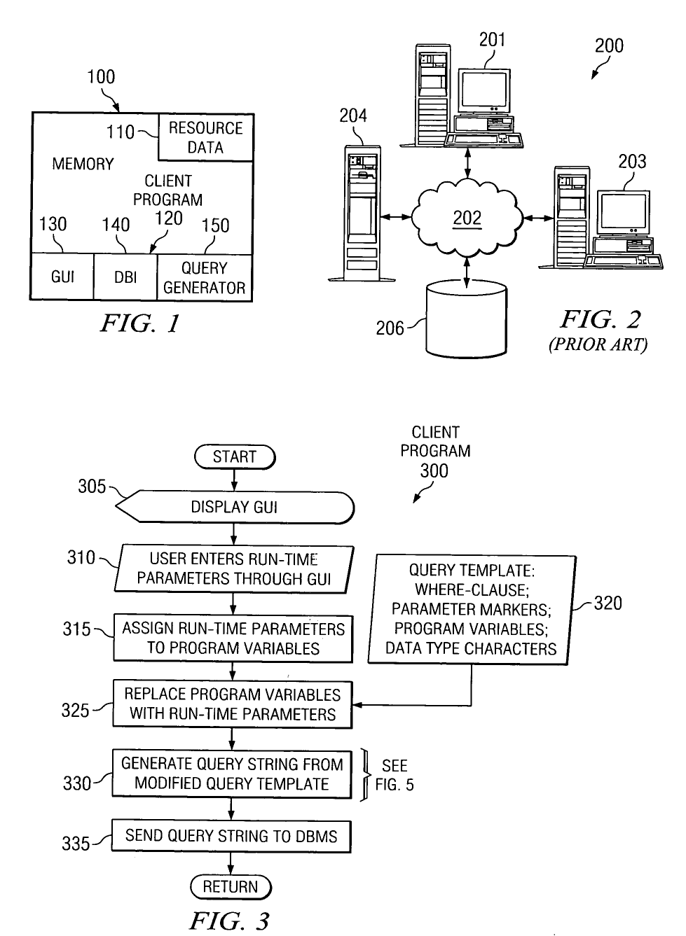

FIG. 2 illustrates a common prior art architecture for connecting various hardware devices to create a network for transferring data. Computer network 200 comprises local computer 201 electrically coupled to network connection 202. In FIG. 2, local computer 201 is coupled electrically to remote computer 203 via network connection 202. Local computer 201 also is coupled electrically to server computer 204 and persistent storage 206 via network connection 202. Network connection 202 may be a simple local area network (LAN) or may be a larger wide area network (WAN), such as the Internet. While computer network 200 depicted in FIG. 2 is intended to represent a possible network architecture, it is not intended to represent an architectural limitation.

Client program 120, database 160, or both can be stored within memory 100 of any computer depicted in FIG. 2. Alternatively, client program 120, database 160, or both can be stored in an external storage device such as persistent storage 206, or a removable disk such as a CD-ROM (not pictured). Additionally, client program 120, as described in detail below, is generally loaded into the memory of more than one computer of FIG. 2 to enable multiple users on different computers to access database 160 over network connection 202. Client program 120 may also interact with multiple databases (not pictured), which also may reside within memory 100 of any computer depicted in FIG. 2.

As illustrated in FIG. 3, client program 120 displays GUI 130 (305), through which a user may enter one or more dynamic parameters as client program 120 operates (310). Alternatively, client program 120 may calculate dynamic parameters based on run-time conditions without any user-supplied parameters. Client program 120 then stores the dynamic parameters within memory 100 as one or more program variables (315). Client program 120 includes one or more query templates 320 that define the basic structure of each potential query that client program 120 may communicate to a DBMS.

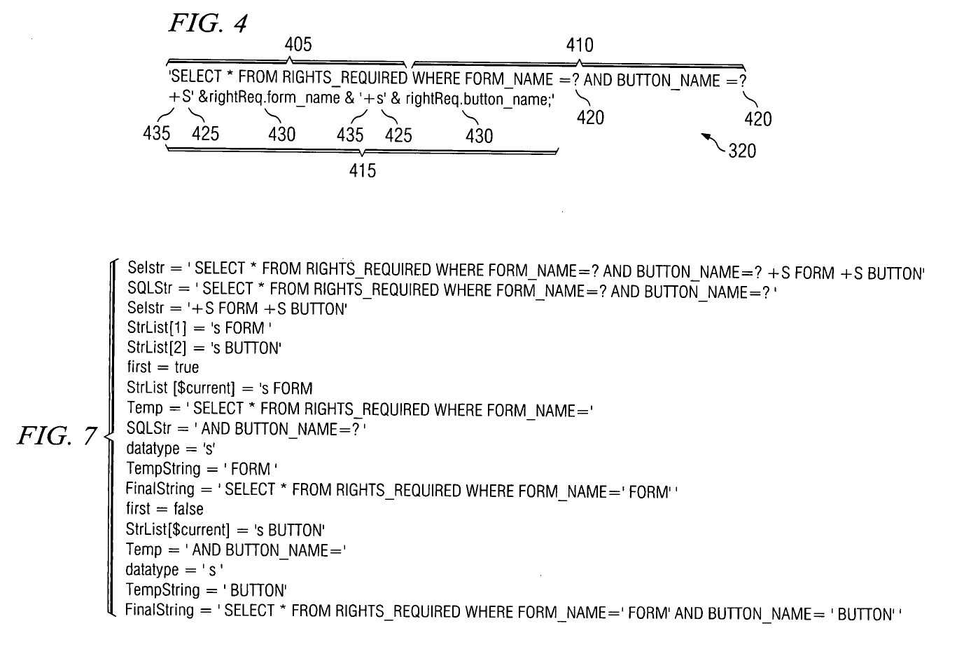

FIG. 4 depicts an exemplary query template 320. Referring to FIG. 4 for illustration, query template 320 is implemented as a string of characters that generally comprise SELECT-clause 405, WHERE-clause 410, and parameter data 415. SELECT-clauses and WHERE-clauses are referred to collectively herein as a “query clause.” Query clauses are supported in most DBMSs that implement SQL. The application of SELECT-clauses and WHERE-clauses to database queries is well known in the art, and need not be described further here. In the preferred embodiment, each parameter marker 420 is incorporated into WHERE-clause 410 to reserve a specific location fol a dynamic parameter within WHERE-clause 410. Parameter data 415 comprises pairs of data type character 425 and program variable 430. Each such pair is ordered within parameter data 415 so that each pair appears in the same relative order as its associated parameter marker appears within WHERE-clause 410. Furthermore, each data type character 425 and program variable 430 pair is separated from other pairs by token character 435. The first such token character 435 within query template 320 also separates WHERE-clause 410 and parameter data 415.

In FIG. 4, for example, SELECT-clause 405 comprises the phrase “SELECT * FROM RIGHTS_REQUIRED” and WHERE-clause 410 comprises the phrase “WHERE FORM_NAME =? AND BUTTON_NAME=?”. Within WHERE-clause in FIG. 4, each parameter marker is represented with the “?” character. Parameter data 415 comprises the phrase “+S’ &rightReq.form_name & ‘+s’ & rightReq.button_name”. Each “+” character within parameter data 415 in FIG. 4 represents token character 435, and each character following the token character represents an example of data type character 425. Also within parameter data 415, the names “rightReq.form_name” and “rightReq.button_name” each represent a different program variable 430. FIG. 4 illustrates an embodiment of query template 320 in which the “s” character indicates that both program variables 430 are string data types. Query template 320, however, is provided for illustrative purposes only. Query template 320 may include one or more program variables of any type, and any character or number can be used as a data type character. Furthermore, FIG. 4 demonstrates an embodiment of query template 320 that has been written in a particular programming language that uses the “&” character as a string concatenation operator. String concatenation operators vary from one programming language to the next, though, and a person of ordinary skill in the art should be able to apply the principles described above to implement query 320 in any desired language.

Referring again to FIG. 3 for illustration, as client program 300 stores the dynamic parameters in program variables, program variables 430 in query template 320 effectively are replaced with the dynamic parameters (325). Client program 320 then generates a query string from modified query template 320 (330). In the preferred embodiment, client program calls query generator 150 and passes modified query template 320 to query generator 150, which processes the query template and returns a query in an SQL-compatible format. A preferred embodiment of query generator 150 is described in detail below.

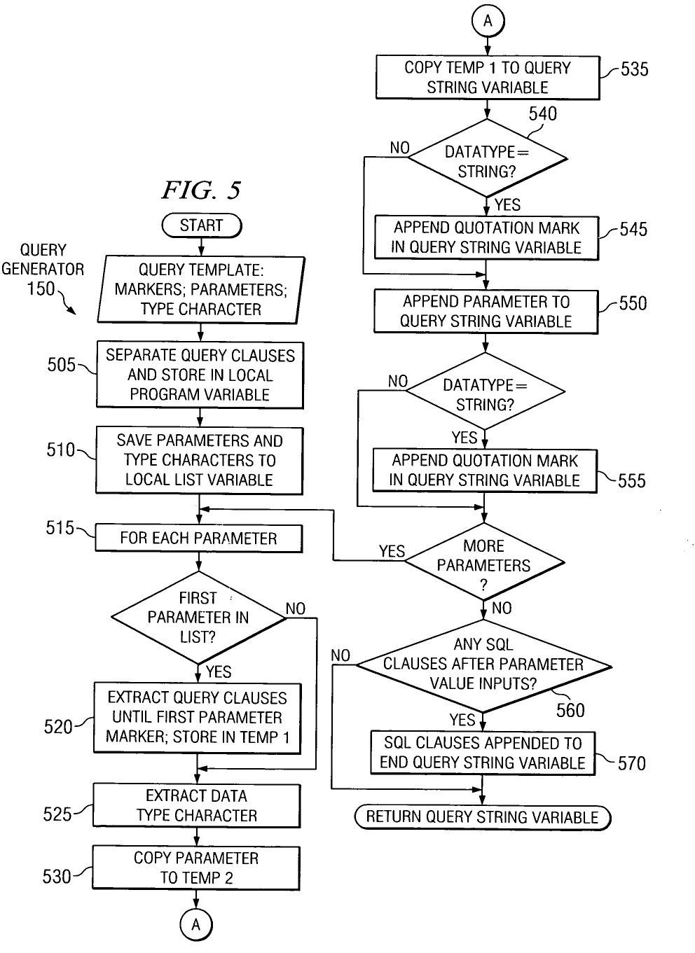

FIG. 5 illustrates a preferred method for implementing query generator 150. As illustrated in FIG. 5, query generator 150 operates on modified query template 320. Query generator 150 uses token character 435 to separate SELECT-clause and WHERE-clause from the rest of query template 320, and then stores SELECT-clause and WHERE clause as a single string of characters in a local program variable (505). Query generator 150 then uses token character 435 to identify data type character and dynamic parameter pairs, and stores each pair as string of characters in an element of a local list variable (510), wherein the data type character is the first character in each element. Query generator 150 then iterates through each element in the local list variable (515). On the first iteration, query generator 150 parses the local program variable and extracts the portion of local program variable comprising the SELECT-clause and the WHERE-clause before the first parameter marker. Query generator 150 stores the extracted portion of local program variable in a first temporary program variable (520). Query generator 150 then extracts the first character from the list element and stores the character in a local datatype variable (525). Query generator 150 then copies the dynamic parameter to a second temporary variable (530). Next, query generator 150 copies the first temporary variable to a query string variable (535) and examines the local datatype variable (540). If the local datatype variable indicates that the dynamic parameter is a string data type, then query generator 150 appends a quotation mark into the query string variable (545). Query generator 150 then appends the dynamic parameter to the query string variable (550). If the local datatype variable indicates that the dynamic parameter is a string data type, then query generator 150 appends a second quotation mark to the query string variable (555). For every subsequent iteration, query generator 150 parses the local program variable and extracts the characters between parameter markers, and continues to append characters to the query string as described above. Finally, after iterating through each element in the local list variable, query generator 150 examines the local program variable to determine if it contains any additional characters not yet processed (560). If the local program variable does contain additional characters, query generator appends the characters to the query string variable (570). Query generator 150 then can return the query string variable to the calling program. DBI 140 then can send query string 320, which query generator 150 returns, to a DBMS for further processing (335), as FIG. 3 illustrates.

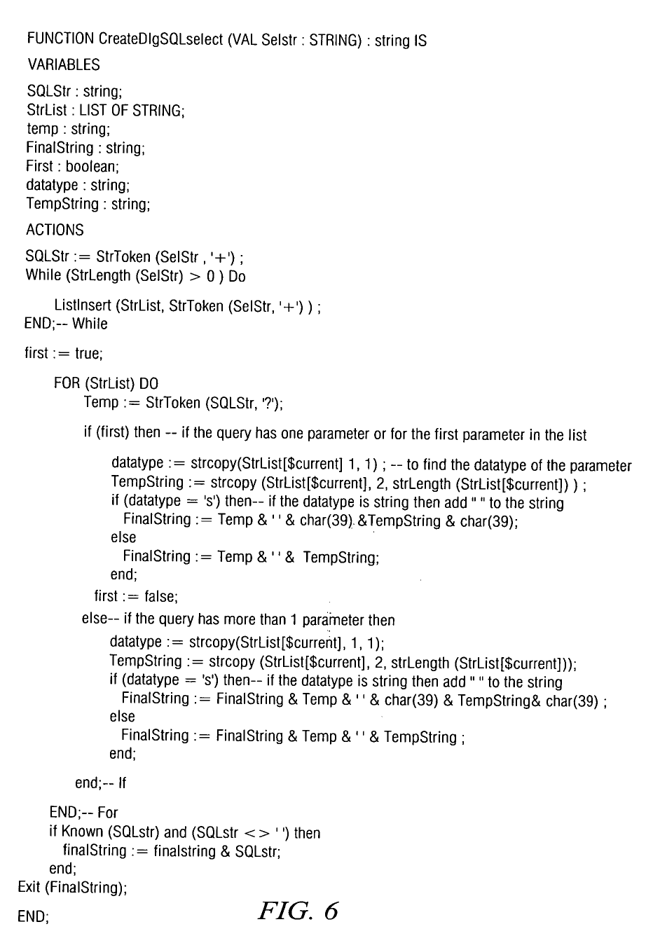

An embodiment of query generator 150 implemented as a program written in Knowledge Markup Language (KML), which implements the process described above, is provided in FIG. 6 for further illustration. FIG. 7 traces the variables in the source code listing of FIG. 6, using the exemplary query template of FIG. 4. For illustrative purposes, FIG. 7 assumes that GUI 130 has provided a form for a user to enter data, and the user has activated a button on the form. FIG. 7 also assumes that a first dynamic parameter having a string value of “FORM” represents the user-selected form, and a second dynamic parameter having a string value of “BUTTON” represents the user-activated button. FIG. 7 further assumes that client program 120 has assigned the first dynamic parameter to the program variable named “rightReq.form_name” and the second dynamic parameter to the “rightReq.button_name” program variable. Query generator 150, then, would receive as the “Selstr” argument a string having the value ‘SELECT * FROM RIGHTS_REQUIRED WHERE FORM_NAME=? AND BUTTON_NAME=?+S FORM+s BUTTON;’. As illustrated in FIG. 7, query generator 150 would ultimately return the value of the “FinalString” variable, which would comprise the string ‘SELECT * FROM RIGHTS_REQUIRED WHERE FORM_NAME=‘FORM’ AND BUTTON_NAME=‘BUTTON’;’.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer program operable on a data processing machine to query a database, the computer program comprising:
a query template, the query template comprising
a query clause having a parameter marker,
a program variable, and
a data type character that indicates the data type of the program variable;
means for accepting a parameter from a user during the operation of the computer program;
means for replacing the parameter marker with the parameter during the operation of the computer program; and
if the data type character indicates that the program variable is a string,
means for placing a first quotation mark in the query template immediately before the parameter, and
means for placing a second quotation mark in the query template immediately after the parameter;
whereby the database can parse the dynamically modified query template and return data based on the parameter the user enters during the operation of the computer program.

2. The computer program of claim 1 wherein the computer program is a helpdesk program and the helpdesk program further comprises:
means for storing and updating problem data in the database.

3. The computer program of claim 1 wherein the computer program is a helpdesk program and the helpdesk program further comprises:
means for storing and updating process change data in the database.

4. The computer program of claim 1 wherein the computer program is a helpdesk program and the helpdesk program further comprises:
means for storing and updating asset data in the database.

5. The computer program of claim 1 wherein the computer program is a helpdesk program and the helpdesk program further comprises:
means for storing and updating problem data in the database;
means for storing and updating process change data in the database; and
means for storing and updating asset data in the database.

6. The computer program of claim 1 wherein the computer program is a helpdesk program helpdesk program comprising KML script, and the KML script further comprises:
means for storing and updating problem data in the database;
means for storing and updating process change data in the database; and
means for storing and updating asset data in the database.

7. A data processing machine comprising:
a processor;
a memory;
a database stored in the memory;
a query template stored in the memory, the query template comprising
a query clause having a parameter marker,
a program variable, and
a data type character that indicates the data type of the program variable; and
a computer program operable on the processor to
accept a parameter from a user;
replace the parameter marker with the parameter;
if the data type character indicates that the program variable is a string,
place a first quotation mark in the query template immediately before the parameter, and
place a second quotation mark in the query template immediately after the parameter;
send the query template to the database;
whereby the database can parse the dynamically modified query template and return data based on the parameter the user enters during the operation of the computer program.

8. The data processing machine of claim 7 wherein the database is a database that supports Unicode.

9. The data processing machine of claim 7 wherein the computer program is a helpdesk program and the helpdesk program further is operable on the processor to store and update problem data in the database.

10. The data processing machine of claim 7 wherein the computer program is a helpdesk program and the helpdesk program further is operable on the processor to store and update process change data in the database.

11. The data processing machine of claim 7 wherein the computer program is a helpdesk program and the helpdesk program further is operable on the processor to store and update asset data in the database.

12. The data processing machine of claim 7 wherein the computer program is a helpdesk program and the helpdesk program further is operable on the processor to
store and update problem data in the database;
store and update process change data in the database; and
store and update asset data in the database.

13. The data processing machine of claim 7 wherein the computer program is a helpdesk program comprising KML script, and the KML script further is operable on the processor to
store and update problem data in the database;
store and update process change data in the database; and
store and update asset data in the database.

14. A process for using a dynamic parameter to generate a query string during the operation of a helpdesk computer program, the process comprising:
creating a query template, the query template comprising
a query clause having a parameter marker,
a program variable, and
a data type character that indicates the data type of the program variable; and
responsive to the user entering the dynamic parameter,
assigning the dynamic parameter to the program variable so that the dynamic parameter replaces the program variable in the query template;
copying a portion of the query clause preceding the parameter marker to the query string;
if the data type character indicates that the program variable is a string, appending a first quotation mark to the query string;
appending the dynamic parameter to the query string;
if the data type character indicates that the program variable is a string, appending a second quotation mark to the query string;
whereby a database can parse the query string and return data based on the dynamic parameters provided during the operation of the computer program.
